(19) United States
(12) Patent Application Publication
(10) Pub. No.: US 2011/0310485 A1
(43) Pub. Date: Dec. 22, 2011

(54) OPTICAL DEVICE AND METHOD OF MANUFACTURE

(75) Inventors: Petr Vizdal, Kralupy nad Vltavou (CZ); Libor Kotacka, Velka Bites (CZ); Tomas Behounek, Hiuboka nad Vltavou (CZ)

(73) Assignee: Optaglio s.r.o., Rez-Husinec (CZ)

(21) Appl. No.: 13/132,061

(22) PCT Filed: Dec. 1, 2009
(86) PCT No.: PCT/EP09/66176

§ 371 Date: Sep. 7, 2011

(30) Foreign Application Priority Data
Dec. 1, 2008 (GB) 0821872.9

(51) Int. Cl. G02B 5/18; G03B 27/32

(52) U.S. Cl. 359/567; 359/569; 359/574; 359/575; 355/77

(57) ABSTRACT

The present invention provides for a diffractive structure comprising a plurality of grooves each formed by a plurality of two-dimensional scattering and/or diffractive groove elements, aligned in a manner serving to provide for at least one diffractive optical effect and further a surface display device comprising a plurality of regions wherein each region has a diffractive surface relief structure as defined above and wherein the gratings of one of said regions at an angle relative to the gratings of another of said regions.

The present invention relates to an optical device and method of manufacture.

In particular, but not exclusively, the invention relates to an optical device that can offer a multiple pattern switch and/or colour effect, and a related method of manufacture.

Further, the method can relate to synthetically written so-called “security holograms” also referred to as Diffractive Optically Variable Identification Devices (DOVI D).

Visually observed patterns of such a nature are generally easy to recognize with the naked eye and as the image presented by the device changes its colour or flops the between positive and negative (e.g. dark and light pattern) versions of the image. Such a visual effect is observed when the device is rotated along an axis perpendicular to the surface of the DOVID. Since the visual effect is easy to recognize, it CaO be advantageously employed for use as an advanced visual anti-counterfeit effect be/ng deployed in a label and indeed other diffractive and/or holographic markers on products such as ID cards, tax stamps, banknotes and many others.

It Is well-known from classical diffractive optics that the period of gratings in visible spectrum, i.e. wavelengths of 400 nm-700 nm, are generally in the order of 500 nm to 2000 nm and also serve to Covera desired and rather broad area of various optically variable effects found in conventional DOVIDs. Thus, the diffractive gratings can be arranged to cover areas from at least a few microns, and up to tens of microns squared, Such micro-areas can then be arranged and/or organized in a plane to create required optical elements.

However, such known devices and methods of their production exhibit disadvantageous limitations as regards the nature and characteristics of the images that can be produced, particularly when used in a security context.

The basic principles of holography are of course known from several books, such as for example, P. Hariharan, Optical Holoaraphy. 2^{nd} ed. Cambridge University Press (1996).

Also diffractive gratings and related elements and various methods for their manufacture have been studied thoroughly and a particulary effective synthetic origination of such elements arises from exploiting the electron-beam lithography and as discussed in Ryzi Z. at al., U.S. Pat. No. 7,435,979. Such synthetic origination can advantageoulsy allow fora very complex shaping of the grooves arising from variation in aspects such as period, and the thickness of the lines creating grooves etc., and as is known from Ryzi Z. et al., WO 2006/013215 A1.

In consideration of the present invention, it should be appreciated that the content of the above-mentioned published documents is incorporated herein by reference.

As with therefore be appreciated, the present invention is based on the fact that, for example, electron beam lithography can be employed to write each “groove element” of a diffractive grating, which can be understood as a set of particular grooves, discretely as a set of, say, microgrooves of characteristic size hundreds microns and which can overlap fully, partially and or be spaced as required. A linear arrangement of such micro-grooves, i.e. when organized along one line with zero overlap, then creates a continuous line and thus a standard groove.

The present invention discloses a novel and advantageous manner of origination of sub-diffractive elements arranged in such a way to yield a desired naked-eye-observable effect.

As will be appreciated from the further discussion below, the invention can be based on considering each single self-standing element of the recorded structure as a two-dimensional diffractive and/or scattering element. Its minimal size in either direction advantageously can be as small as 10 nm, and which allows for a resolution of approximately 2.5 million dpi to be achieved. The maximal size in either of the element direction is not actually limited and CaO increase to millimeters or even centimeters. However in a preferred arrangement the dimensions are arranged to increase in a multiple of 10 nm In general, the size of the element can spans a suitable range from 10 nm to tens of microns.

These diffractive/scattering objects can be mutually displaced or relatively spaced with a step of 10 nm, and its multiple, and this translates to a resolution of approximately 2.5 million dpi. The shape can be as required but particular examples can be quadrilateral and preferably substantially rectangular.

Thus, each single element can be as small as a square of size 10 nm and located in the field with the resolution of 10 nm.

The present invention advantageously therefore offers a unique, difficult to imitate high-security optical feature. As a further advantage, such features can routinely be combined with any optically variable features and devices, especially with those being originated via the eleCtron beam lithography, since the features can then be originated in one lithographic run.

Furthermore, the features of the invention discussed herein can be advantageously combined with other covert, as well as overt, diffractive and related security features and techniques.

As will be appreciated, the invention can exploit preferably an electron beam lithograph, or focused ion beam assisted writing, although some advanced direct optical writing techniques may be used to achieve the desired features of the invention. Of course the control software for the chosen exposition is arranged as required to provide the appropriately accurate writing technique. Origination techniques other than the electron beam lithograph are assumed to be employed in forming the exemplified optical device structures described further below.

The invention is described further hereinafter, by way of example only, with reference to the accompanying drawings in which:

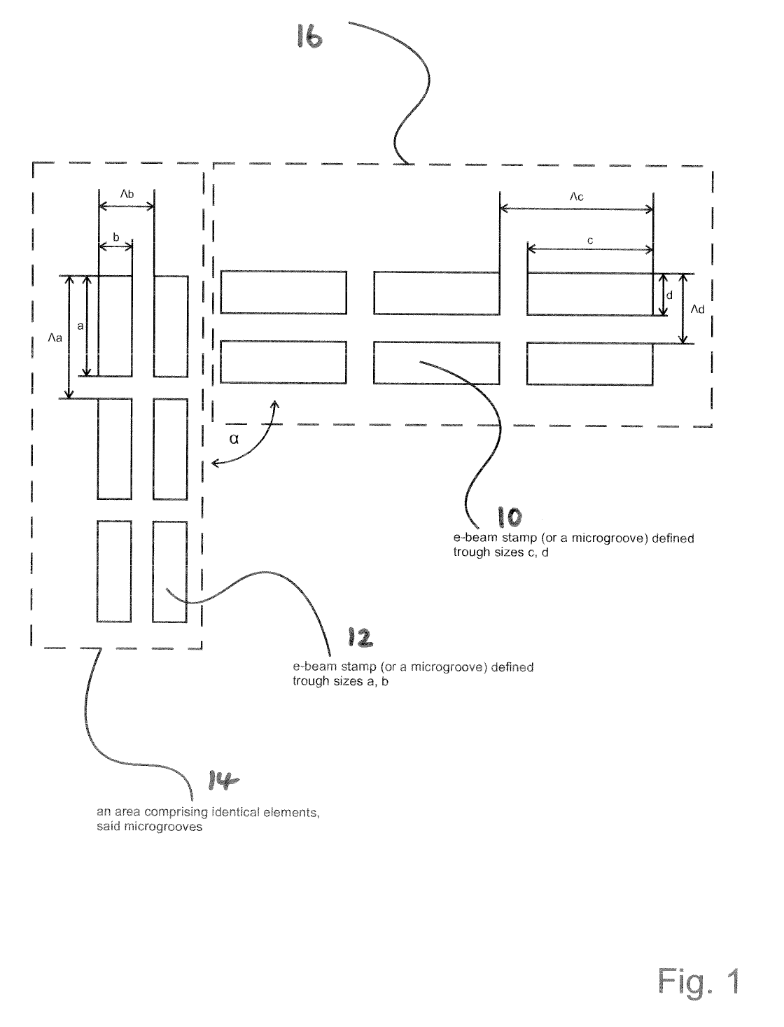

FIG. 1 is a schematic representation of a portion of a structure embodying the present invention and comprising discreet groove elements;

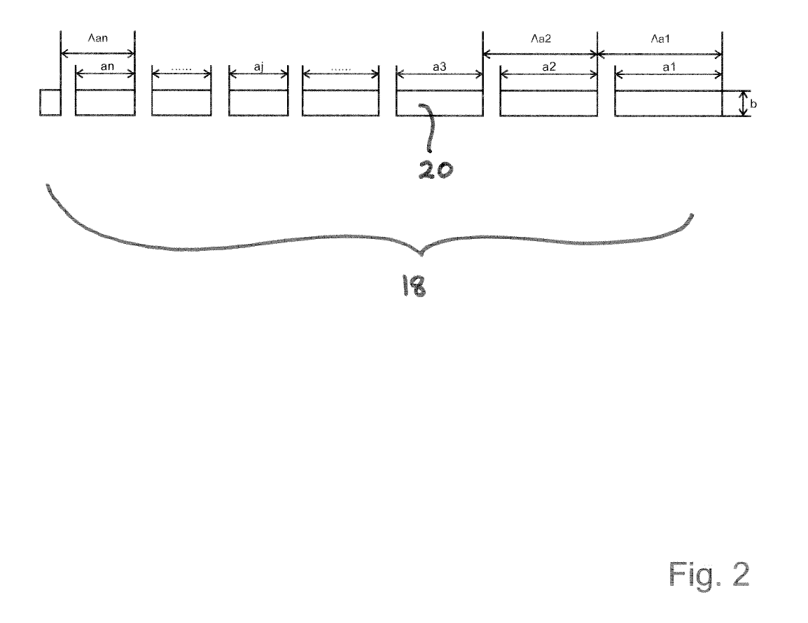

FIG. 2 is an illustration of one example of possible alignment of discreet groove elements of a structure embodying the invention;

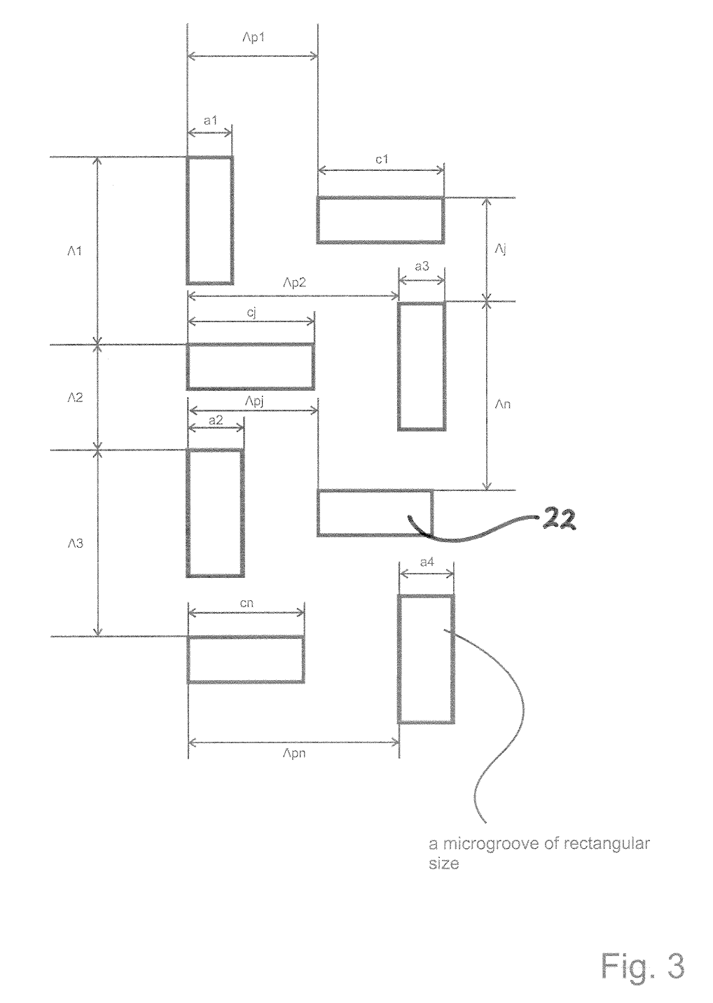

FIG. 3 is an illustration of another example of possible spaced relationships of the groove elements according to an embodiment of the invention;

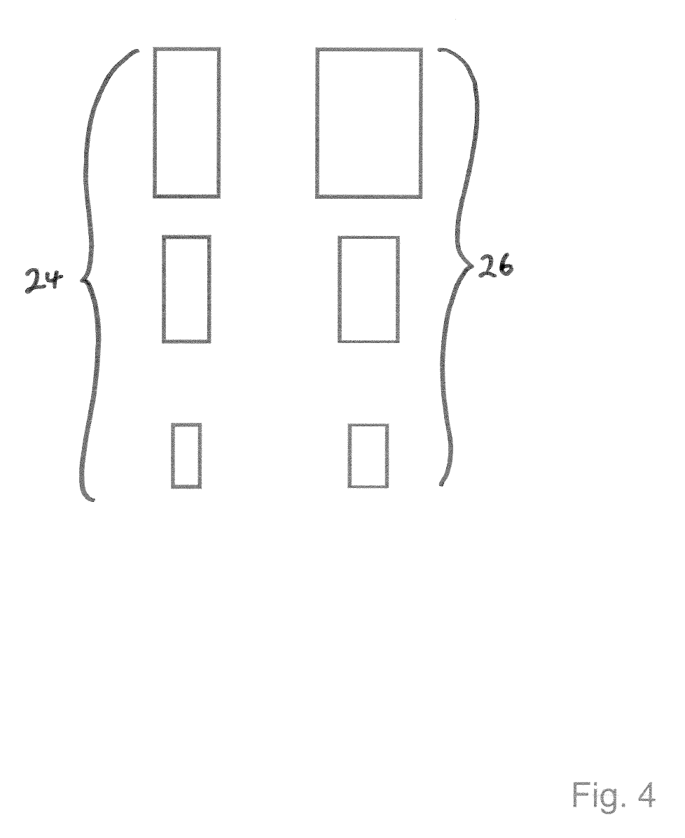

FIGS. 4 to 6 illustrate examples of yet further variations;

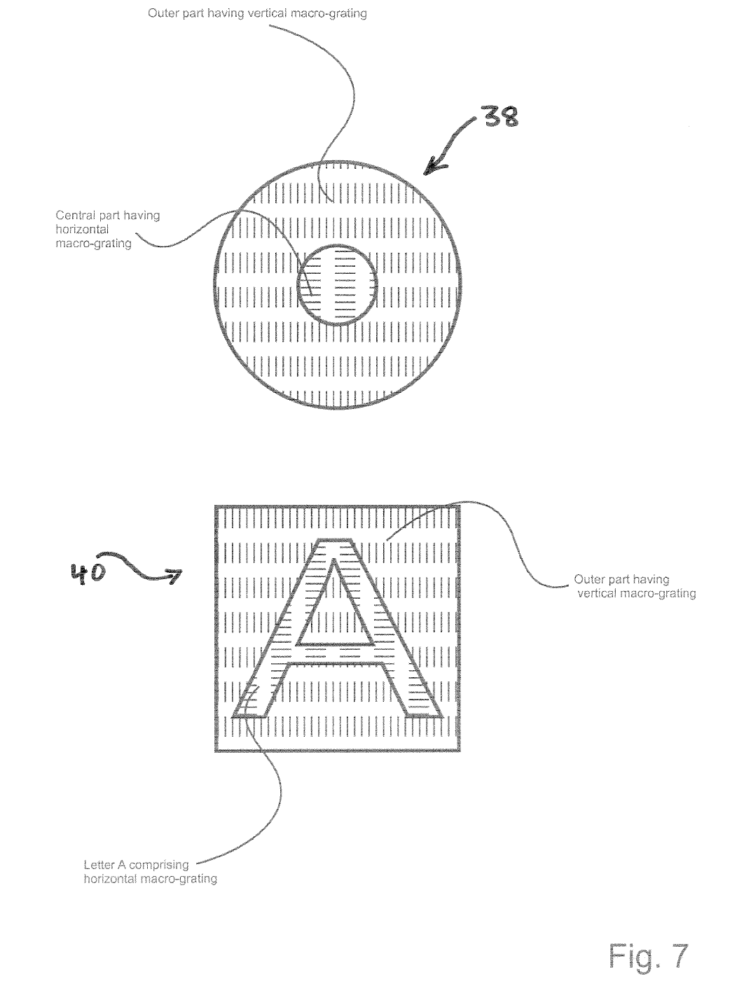

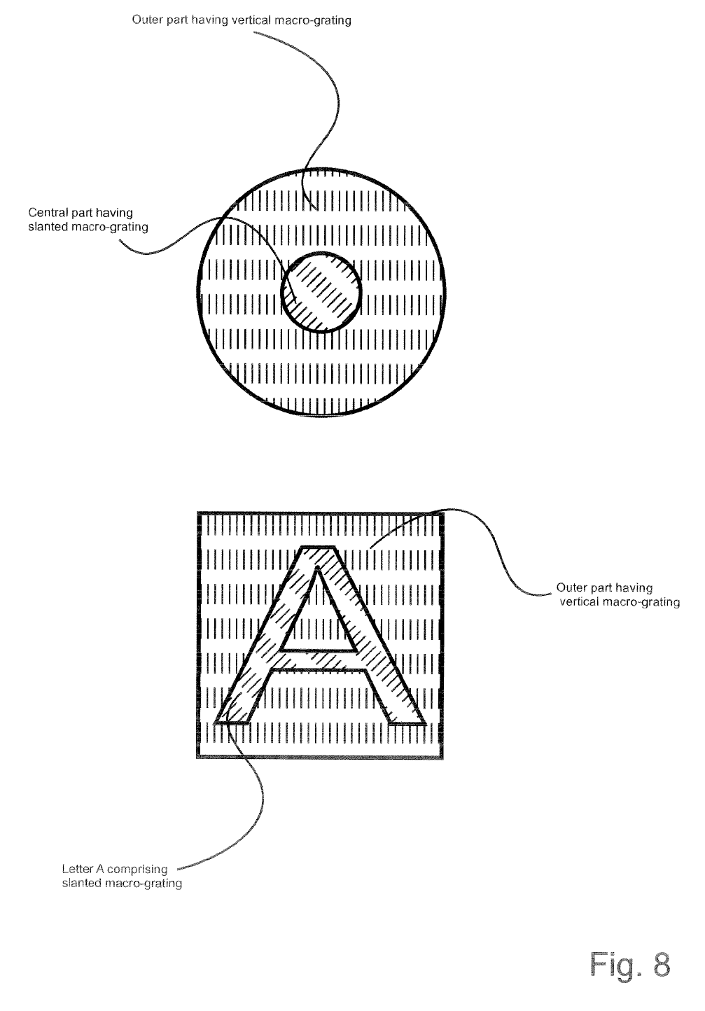

FIGS. 7 and 8 illustrate examples of surface display devices according to embodiments of the present invention;

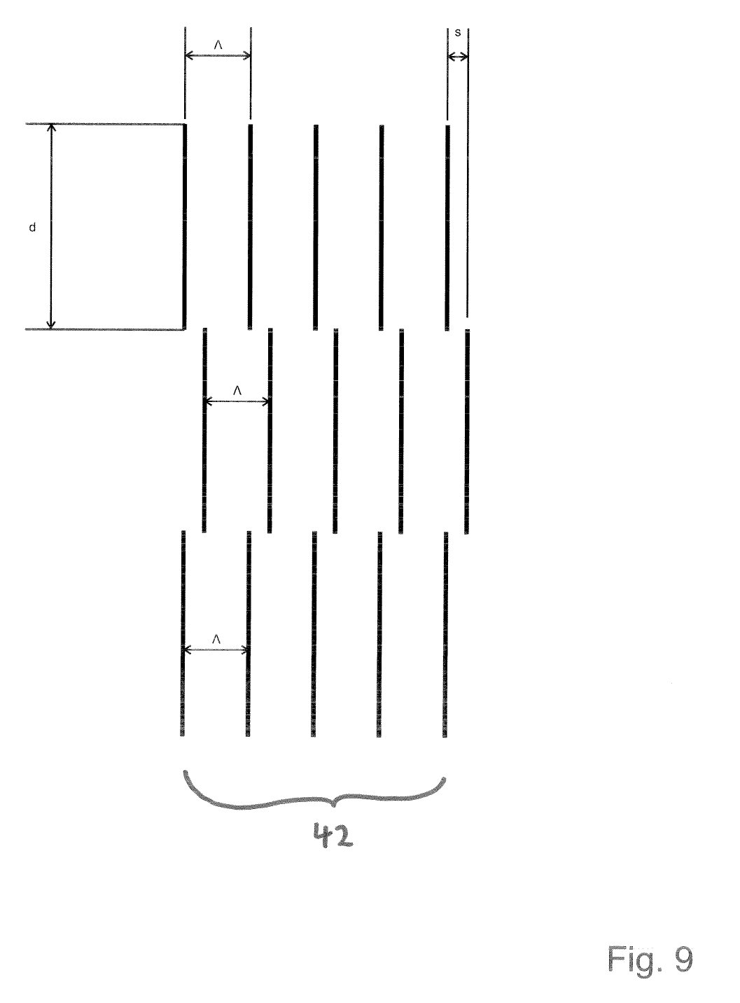

FIGS. 9 to 13 illustrate various linear relationships that can be employed for the groove elements within structures embodying the invention;

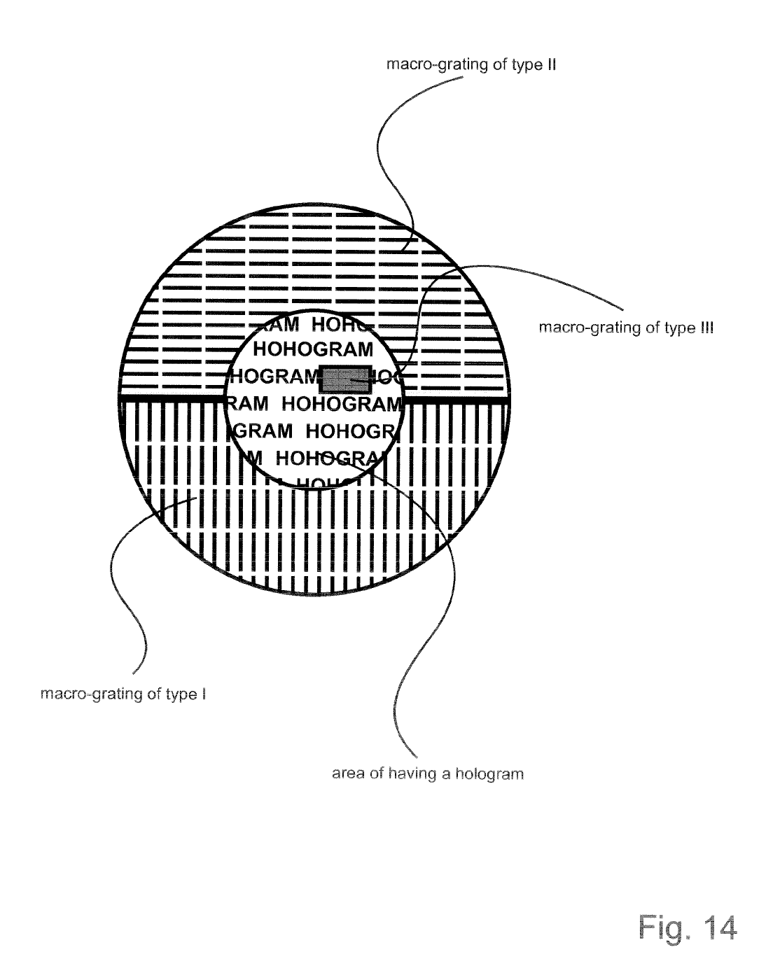

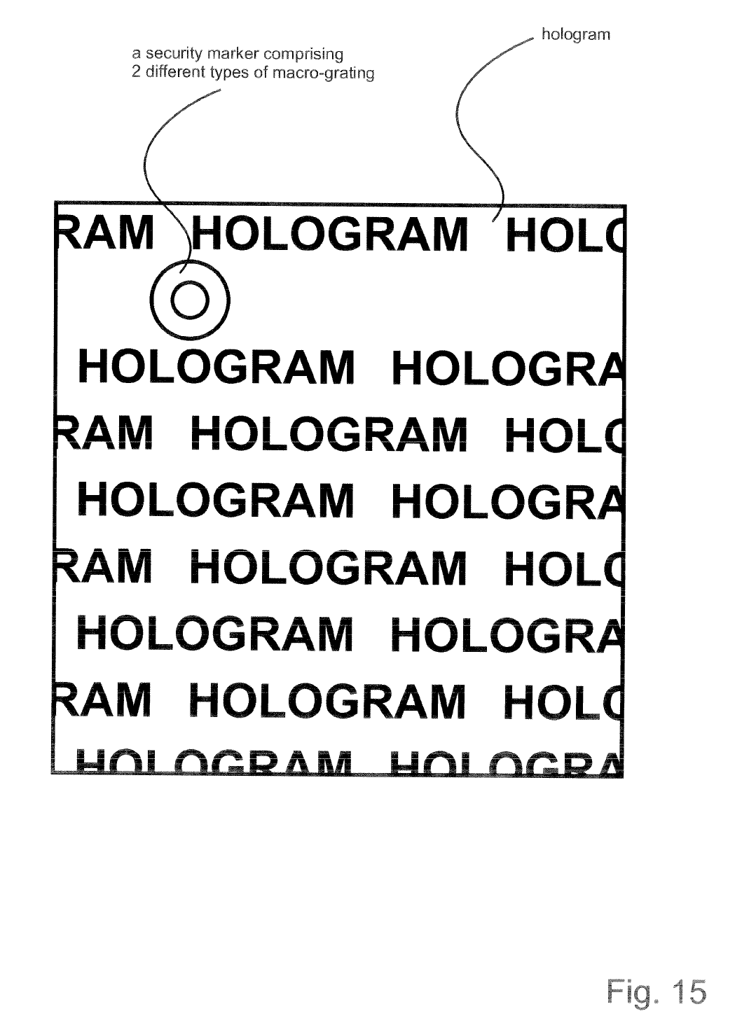

FIGS. 14 and 15 illustrate further examples of surface display devices embodying the present invention;

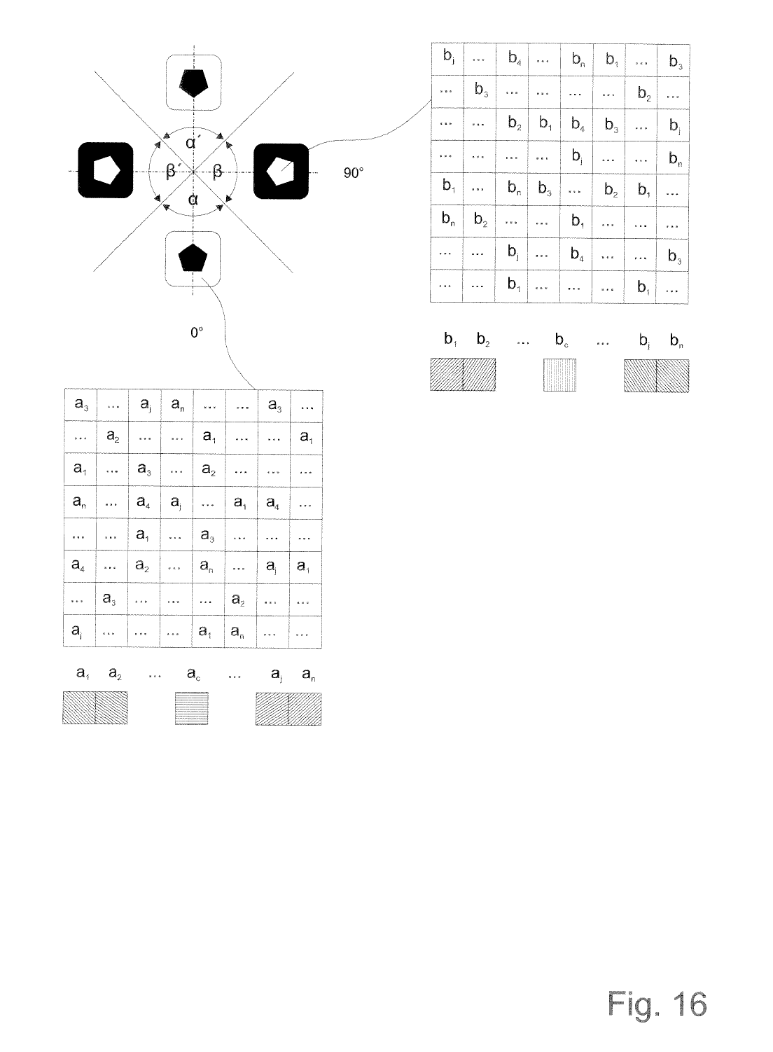

FIG. 16 illustrates image switches resulting from mosaic patterns of diffractive structures embodying the invention;

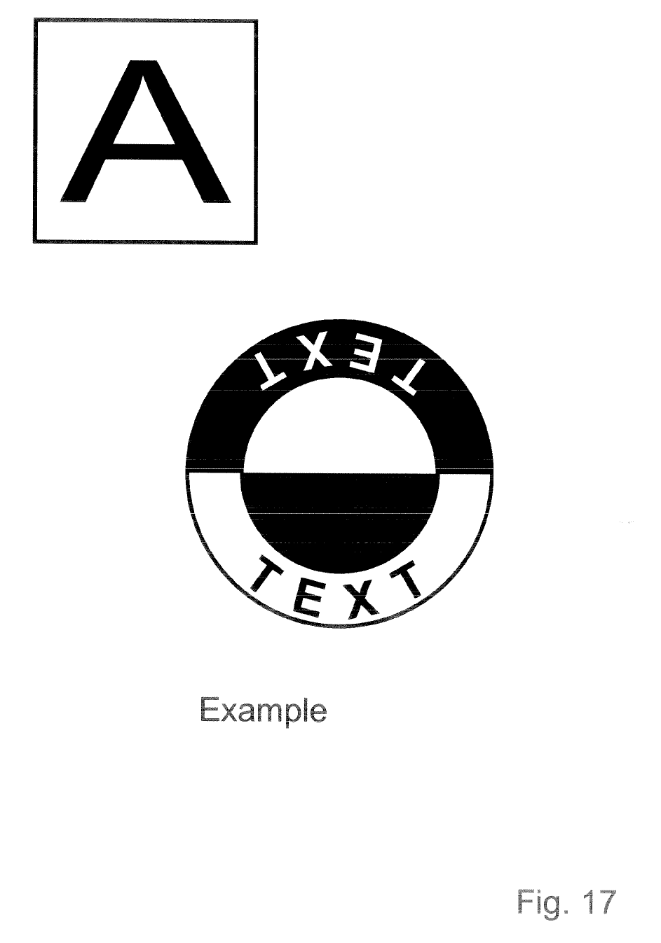

FIG. 17 illustrates a further possible image switch; and

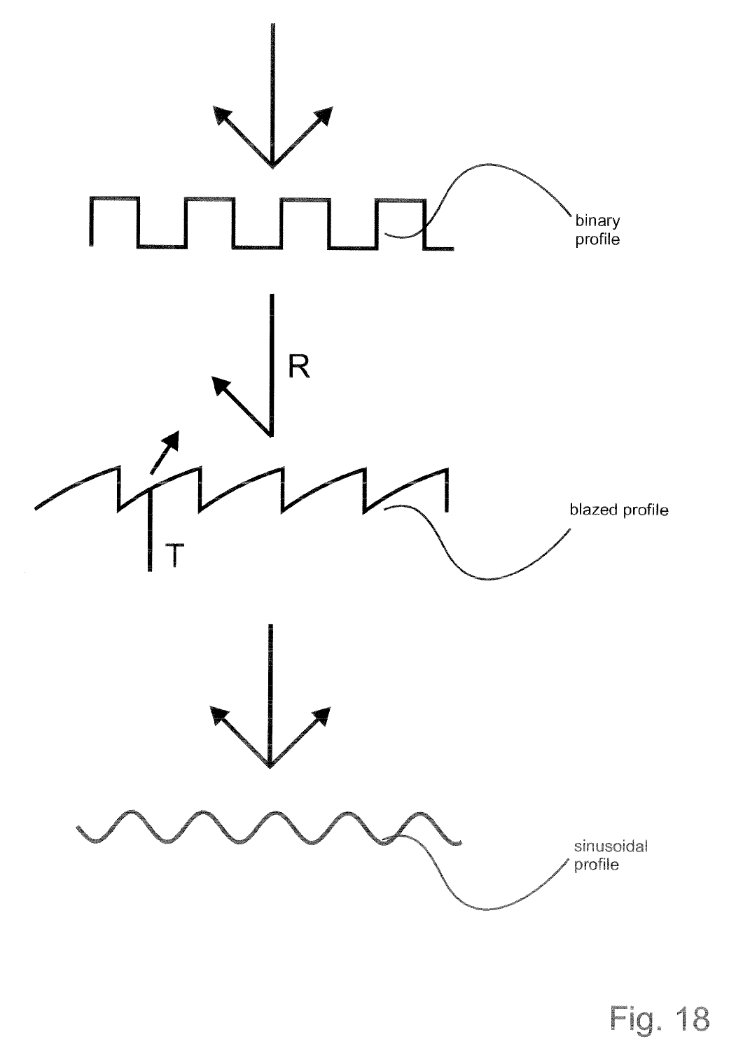

FIG. 18 illustrates likely grating profiles that can be employed within the elements forming structures embodying the invention.

With reference first to Fig.1, examples of the groove elements 10, 12, or so-called micro-grooves of submicron sizes can be as follows. FIG. 1. defines two areas 14, 16 each comprising a plurality of the single e-beam stamps 10, 12, thus creating at least two 2-dimensional gratings, characterized by sizes of the microgrooves a, b, c, d, and their periods Λₐ, Λ_{b}, Λ_{c}, Λ_{d}. The micro-grooves in one direction (e.g. vertical) are of sizes a, b, with periods Λₐ and Λ_{b} whilst the other direction (horizontal shown for the sake of simplicity) are defined through the sizes a₂, b₂. Similarly, c, d, Λ_{c}, Λ_{d} define the microgrooves in the other region.

Finally, the mutual azimuth between the regions is defined through the angle α. Compared with standard grooves of a linear diffraction gratings, the grooves appear to be intermittent and such an arrangement creates a double period grating, sometimes called cross-gratings.

It should be appreciated that only very trivial cases of the devices disclosed in this text can be roughly imitated by the so called crossed grating (see G. H. Derrick, Appl. Phys., vol. 18, pp. 39-52 (1979). However, even the shape of particular diffractive elements is defined through the conventional holography origination arrangement.

These features serve to govern flexibly the spectral properties of the diffractive gratings in at least two directions (perpendicular). For a device comprising such grating comprising the diffractive elements as defined above, said micro-grooves, would yield under a well defined lighting conditions remarkably different optical pattern if rotated by 90 degrees along the axis perpendicular to the plane of the device. For example, the device will change the colour when observed under the same angle.

FIG. 2. depicts a general way of definition of one line 18 defined through various length of the microgrooves 20 with different mutual periods, rather spacings, among them. The minimum size of each parameter is 50 nm, they can be increased with an increment of 10 nm.

FIG. 3. is similar to FIG. 2., but illustrates the microgrooves 22 with different parameters and wherein the grooves may be spatially arranged in the plane of the DOVID as shown.

Turning to FIG. 4, schematically this shows that various stamps may appear in respective lines 24, 26 i.e. corresponding to an original groove, however the period in the vertical direction is kept constant.

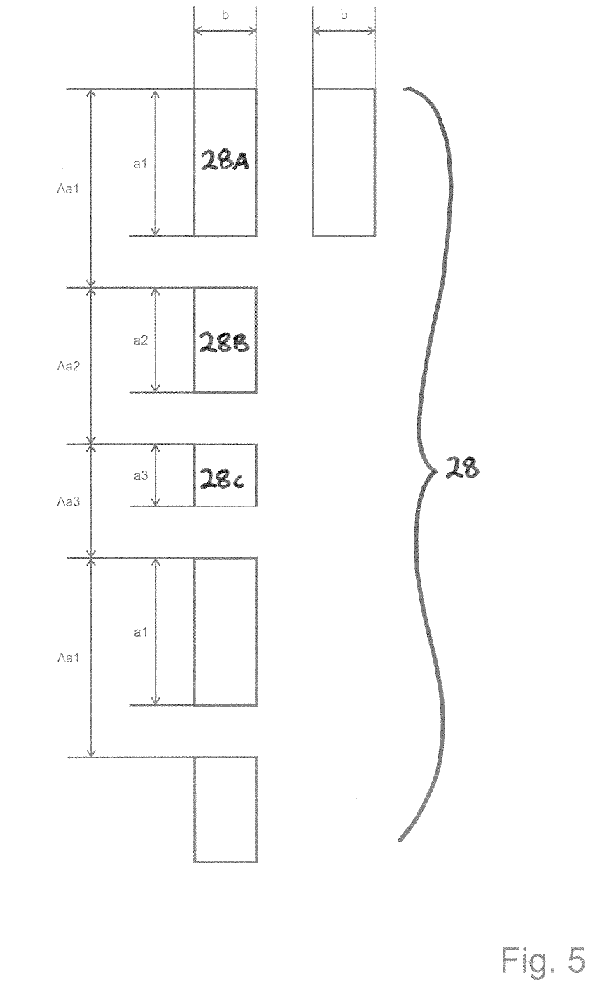

FIG. 5. illustrates an example of microgroove 28 spacing exhibiting specific quasi-periodic characteristics consisting of three specifically chosen micro-grooves 28A, 28B and 280 with three different, thus pertinent, periods in one direction. The period in the other dimension is held constant as well the dimension b of microgrooves 28. This can advantageously provide for a device having one specific colour in one direction, whilst the colour in the other direction will be controlled though a set of three sub-diffractive elements and their elements.

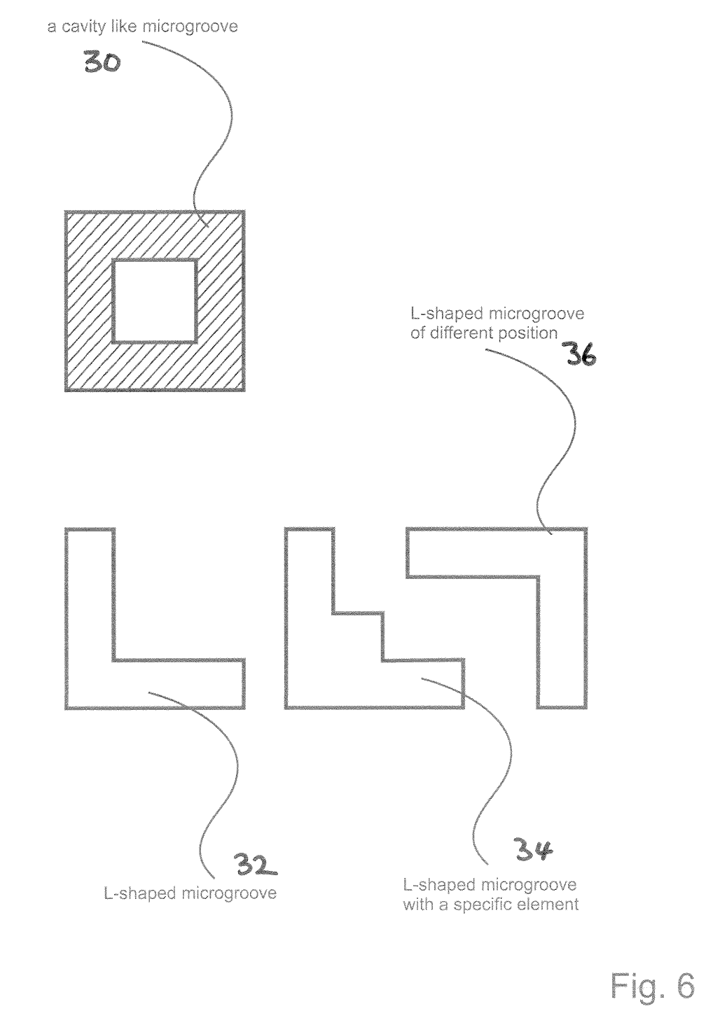

As an example, and from FIG. 6, it will of course be appreciated that electron beam lithography can offer quite a variety of different shapes for the elements (30-36) and which can be employed to generate quite peculiar diffraction patterns.

FIG. 7 shows two examples 38, 40 of an entire surface display device each consisting of two different regions comprising different sets of diffractive the groove element microstructures, i.e. microgrooves of the present invention. The inner and out regions are demarcated, e.g. by a boundary defining a letter of some simple graphical motif. Rotating such device, the regions will change their colour. The invention allows for the period of the elements to be equal for each structure such that, when rotated, the colour will interchange after a rotation of 90 degreed. This offers and advanced version of a color holographic watermark of preferably complimentary colours.

FIG. 8 is similar to FIG. 7, except that it should be appreciated that the lines in the regions are not perpendicular to one another. This can serve to create a so-called flip-flop holographic effect compared with that observed for right angle rotation. This can readily be extended to a multiple flop effect.

Further examples of controlled alignment are found in FIG. 9 which illustrates an ordinary linear grating (with a constant period A) with a region of slightly shifted grooves 42 (of the distance s) relative to a notional line of alignment. This will create and ordinarily looking diffraction grating, however when observed through a transparent linear grating of the identical period with no additional perturbation will display the region with shifted grooves such as a so-called diffractive Moire effect.

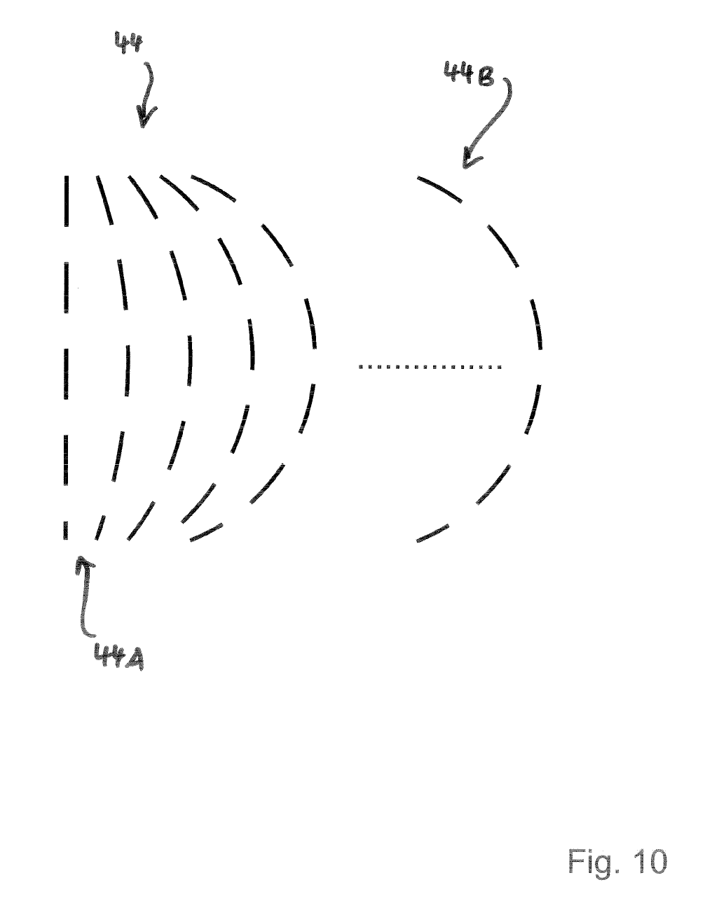

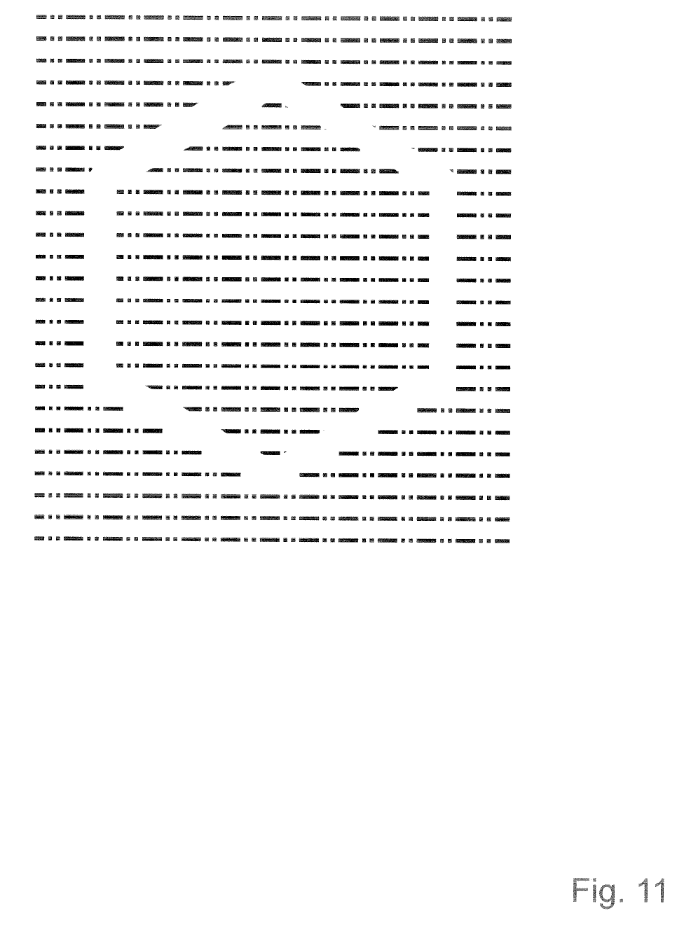

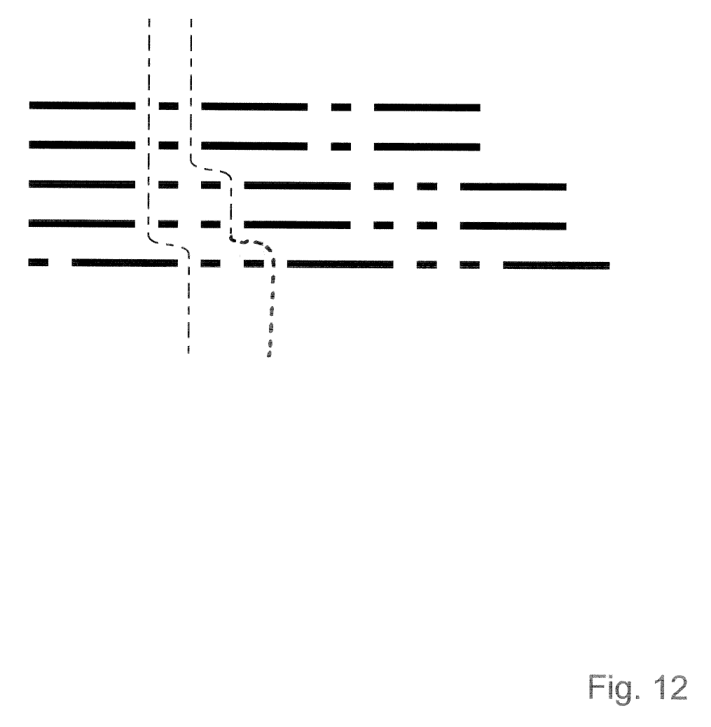

The further feature of FIG. 10 is that a line 44 consisting of microgrooves may continuously change its overall shape, e.g. from a linear line 44A to a semicircle 44B etc. Within FIG. 11, the spacing among the grooves may create a macroscopically observable (even by the naked eye) motif, such as for example the hexagon shown in that drawing. This aspect is further extended in FIG. 12, where the dashed lines schematically indicate a certain graphical motif being determined via a global micro-grooves arrangement, while the principal functionality of the microgrgoves remains untouched.

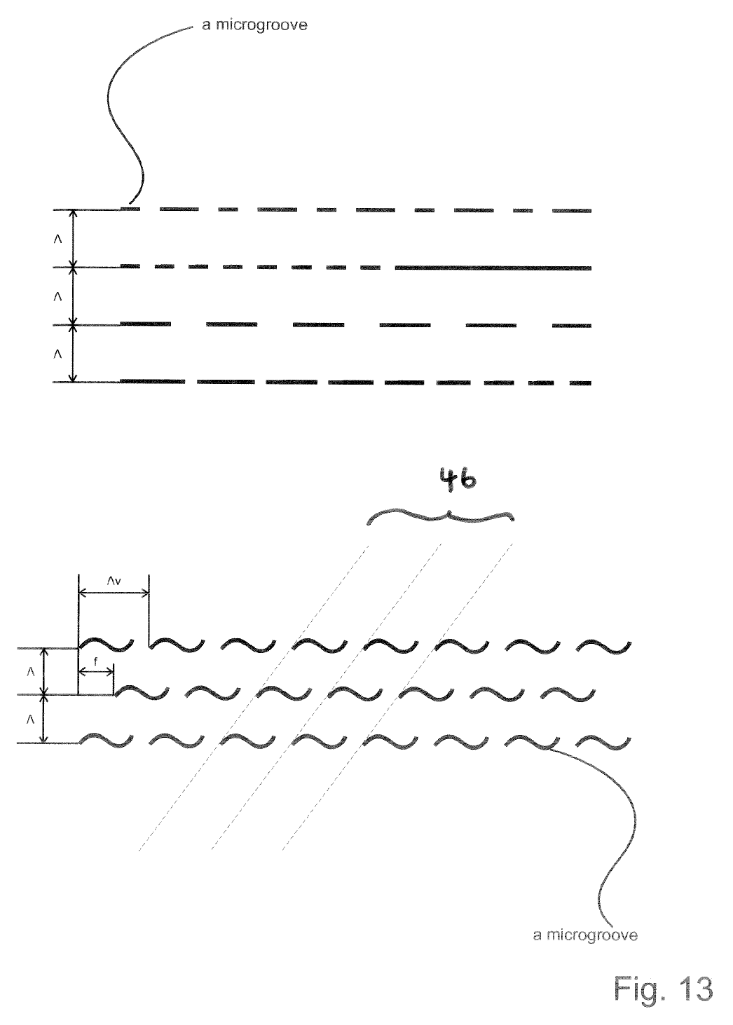

FIG. 13 introduces a special quasiperiodic embodiment of the invention wherein one dimension is kept with constant period, while the lines are horizontally organized, even randomly if required. This would yield a controllable “diffractive-white” perception. The lower part of FIG. 13 illustrates a quasi periodic arrangement of a wavelet-like motif, and the shift f is advantageously employed to yield an additional extra visible effect, as the diffraction maxima will of course be observed in the direction perpendicular to the dashed lines.

While primarily for illustrative purposes, the grating grooves are drawn as single lines, they could however be of a complex variable form for example as known from WO 2006/013215 A1. This would yield a specifically advantageous structure for the security purposes, as it links to an achromatic, or achromatic-like, three-dimensional appearance, but having a controlled colour or white (matt-like) ovservable effect in one or more directions and according to the relative position of the light source and the observation direction. This will link a unique feature of advanced diffractive devices, for example, three dimensionally standard holographic picture and diffractive gratings, with the features according to and arising from, the present invention.

FIG. 14 shows an example of DOVID with different regions containing different macro-gratings, where each macro-grating is defined through a set of micro-grooves (preferably identical). A separate further area of the DOVID contains a standard security hologram and a similar further example of the possibilities is illustrated in FIG. 15.

FIG. 16 describes an advanced optical feature explained as a simple case and comprising a so called “quatro-flop” and in general where the number of flops is from two or more positions. The device is made through a complex mask, where particular and either full-size linear gratings, or gratings consisting of the micro-grooves discussed above, are located in a predefined region. For example, gratings, or rather cells comprising such gratings, with certain parameters such as period, groove slope and shape, b₁ . . . , b_{c}, . . . , bⱼ, . . . bₙ, are arranged as shown on the drawing and preferably in random order. The “b-type” gratings yield visibility of the elements in one direction, whilst the “a-type” gratings ensure the same in a direction perpendicular to b-type gratings. This actually holds for the central gratings (aₛ, b_{c}, respectively). Hatching on the figure is representative of the groove directions in the pertinent subpixel, aⱼ or bⱼ. The flop is achieved when rotating the whole device and the particular gratings are arranged in such way to display a macroscopic motif (pentagon in rounded square on the picture) and flops the contrast level from “white to dark” (theoretically positive to negative) similarly to well known diffractive watermark. However, contrary to the diffractive watermark, where the flop feature occurs for each 180 degrees rotation, the embodiment of FIG. 16 provides for flopping the motif to the negative and back for each 90 degrees as also shown schematically in the drawing. This further yields a unique feature that the element is visible from as broad interval as 360 degrees.

Another interesting application derived from the principles described through FIG. 16 is the synthetic simulation of the pictures known from conventional holography. These are the figures with virtual three dimensional perception. If we first consider the only matrix of grating elements, say b-type (FIG. 16), each bⱼ subpixel now bears such information relating to a projection (similar to photography) of a #D motif. For example b₁ belongs to a view on a motif from a certain direction, b₂ belongs to a view on the same motif from an adjacent angle. So, bₙ subpixels carry information from the other side of the predetermined interval of observation angles (angle_{—}1, angle_{—}2, angle_n). Each subcell bⱼ depicts the full info (with 1/n intensity of the figure). A color(s) and actual intensity of a pertinent elements is defined through the grating period, shape of grooves, density of the grooves in the subpixel, slope of grooves etc. This results to the following illusion. The gratings (subcells) relative to the view of the figure emit the light (relating to a given view) into the desired direction etc. b₁ into the angle_{—}1. We thus synthetically build the spectacular impression of the quasi three-dimensional effect. This can further be exploited to depict an illusion of either moving three-dimensional object similarly to the conventional holography. More importantly, we can also simulate the relative movement of the light source with respect to a three-dimensional body or scenery being observed. Thus, an easy inspection by the naked eyes offers a unique spectation of moving the shadow of the three dimensional motif when moving the synthetic hologram. A variety of arbitrarily effect and expecially “non-natural” effects (like contra-propagating movement, or stepwise behavior of the movement) are achievable.

Yet further, this feature of FIG. 16, when accompanied by the substantial devices described WO 2006/013215 A1 offers a unique device having unexpected 3D dimensional spectation. Most likely the features of WO 2006/013215 A1 (called nanogravure in the text) yield a bulging like effect, however the role of the invention described through the features of FIG. 16 of the present application would produce an optical illusion emphasizing the three dimensional perception as a fictive shadow from the nanogravure motif.

Turning now to FIG. 17, there is shown a simple case of the quarto-flop, when the text and the pertinent semicircle (black or white shown for the simplicity) change their observation contrast when rotated in a manner described above in relation to FIG. 16.

FIG. 18 shows all known, and likely most typical grating profiles suitable for micro-gratings employed within the present invention and even substantially space modulated grating groove profiles as described in WO 2006/013215 A1 are suitable for further use according to the present invention.

It should of course be appreciated that the invention is in no way restricted to the details of the embodiments outlined above and, in particular, the many features of such embodiments can be employed in any appropriate combination as required.

1. A diffractive structure comprising a plurality of grooves each formed by a plurality of two-dimensional scattering and/or diffractive groove elements, aligned in a manner serving to provide for at least one diffractive optical effect.

2. A structure as claimed in claim 1 and comprising a surface relief structure.

3. A structure as claimed in claim 1, wherein at least one of the said plurality of elements is formed by a single exposition.

4. A structure as claimed in claim 1, wherein at least one of the said plurality of elements is formed by multiple expositions.

5. A structure as claimed in claim 4, wherein the said at least one element is of arbitrary shape.

6. A structure as claimed in claim 1, wherein at least two of the said elements are conjoined in a contiguous manner along the direction of alignment.

7. A structure as claimed in claim 1, wherein at least two of the said elements are in a spaced apart relationship.

8. A structure as claimed in claim 7, wherein the period of the spaced elements is constant.

9. A structure as claimed in claim 7, wherein the spacing of the said separated elements is constant.

10. A structure as claimed in claim 7, wherein the period at least some of the separate element is not constant.

11. A structure as claimed in claim 7, wherein the spacing between at least some of the spaced element is not constant.

12. A structure as claimed in claim 1 and arranged such that the separation of the aligned element also serves to form a diffractive structure.

13. A structure as claimed in claim 1 wherein the said plurality of elements are in substantially straight alignment.

14. A structure as claimed in claim 1, wherein the plurality of elements are in a substantially curved alignment.

15. A structure as claimed in claim 1 wherein the plurality of elements are in staggered relationship with respect to a notional line of alignment.

16. A structure as claimed in claim 15, wherein the said staggered relationship exhibits a shift serving to create a Moire.

17. A structure as claimed in claim 1 wherein the said plurality of elements have a minimum dimension of 10 nm and wherein the release structure can have a resolution of 2.5 million dpi.

18. A structure as claimed in claim 1 wherein the minimum separation between at least two of the elements is 10 nm and wherein the resolution of the structure can be 2.5 million dpi.

19. A structure as claimed in claim 1 wherein at least one of the said elements comprises a quadrilateral.

20. A structure as claimed in claim 1 wherein the groove elements are arranged to form a micro or macro observable graphical feature.

21. A surface display device comprising a plurality of regions wherein each region has a diffractive surface relief structure as defined in claim 1, wherein the gratings of one of said regions at an angle relative to the gratings of another of said regions.

22. A surface display device as claimed in claim 20, wherein the said angle comprises substantially a right angle.

23. A surface display device as claimed in claim 20, wherein the plurality of regions of different grating angles are arranged to provide for differing optical effects which can include colour flips, and image flips and/or variations of a three-dimensional image.

24. A device as claimed in claim 23, wherein the colour flip comprises an alternating flip between two colours.

25. A device as claimed in claim 23, wherein the three-dimensional effect comprises a holographic simulation.

26. A surface display device as defined in claim 23, and comprising a mosaic of the said plurality of regions.

27. A surface device as defined in claim 26 and presenting at least one image observable omnidirectionally.

28. A surface device as defined in claim 26, and presenting an image as a grey flop or colour flop.

29. A surface device as claimed in claim 26, and including at least a further region presenting a further optical effect which can include a holographic region.

30. A method of creating a diffractive surface relief structure comprising forming a plurality of two-dimensional scattering and/or diffractive groove elements, said elements being formed in an alignment serving to form a groove arranged in a manner to provide for at least one diffractive optical effect.

31. A method as claimed in claim 30 and forming at least one of the plurality of elements by way of a single exposition.

32. A method as claimed in claim 30 wherein one of the said elements is formed by multiple expositions.

33. A method as claimed in claim 30, and forming at least two of the said elements in a contiguous manner.

34. A method as claimed in claim 30 and forming at least two of the said elements in a spaced relationship.

35. A method as claimed in claim 34 wherein the period of spaced elements is constant.

36. A method as claimed in claim 34, wherein the space between the said spaced elements is constant.

37. A method as claimed in claim 34, wherein the period of the spaced elements is not constant.

38. A method as claimed in claim 34, wherein the spacing between at least some of the elements is not constant.

39. A method as claimed in claim 34, wherein the plurality of said elements are aligned in a spaced relationship such that the spacing also serves to form a diffractive structure.

40. A method as claimed in claim 34, and forming at least some of the plurality of elements in a straight line.

41. A method as claimed in claim 34, and including the step of forming at least some of the plurality of elements in a curved line.

42. A method as claimed in claim 34, and including the step of forming the plurality of elements in staggered relationship to a notional line of alignment.

43. A method as claimed in claim 34, and including forming the plurality of elements with minimum dimensions of 10 nm.

44. A method as claimed in claim 34, and forming the plurality of elements with a minimum separation of 10 nm.

45. A method as claimed in claim 34, wherein the said plurality of elements comprise quadrilateral elements.

46. A method of forming a surface display device comprising forming a respective plurality of structures according to a method of claim 34 in respective regions of the surface display device wherein the direction of alignment within one of the respective regions is different from that of another of the said respective regions.

47. A method as claimed in claim 46, wherein the directions of alignment of the respective regions are substantially orthogonal.

48. A method as claimed in claim 34 and including forming the plurality of elements by an electron-beam exposition.

49. A method as claimed in claim 48, wherein the electro-beam exposition includes focused ion-beam assisted writing.
